(19) United States
(12) Patent Application Publication
(10) Pub. No.: US 2017/0153430 A1
(43) Pub. Date: Jun. 1, 2017

(54) PROJECTION LENS AND IMAGE PROJECTION APPARATUS

(71) Applicant: CANON KABUSHIKI KAISHA, Tokyo (JP)

(72) Inventors: Ryo Iijima, Utsunomiya-shi (JP); Makoto Takahashi, Utsunomiya-shi (JP)

(21) Appl. No.: 15/358,585

(22) Filed: Nov. 22, 2016

(30) Foreign Application Priority Data
Nov. 27, 2015 (JP) 2015-231840
Nov. 4, 2016 (JP) 2016-216668

(51) Int. Cl. G02B 15/177; G02B 27/28; G02B 27/00; G02B 13/16; G02B 1/04

(52) U.S. Cl. CPC G02B 15/177; G02B 13/16; G02B 1/041; G02B 27/0025; G02B 27/283

(57) ABSTRACT

The projection lens includes at least one plastic lens having a negative power and disposed on an enlargement conjugate side further than a reduction conjugate side pupil. The projection lens satisfies 1.4≦ft/fw≦2.5, −0.70≦ft/f_{PL}≦−0.33 and −1.0≦1−(fnot×L×tan(ωt))/ft≦0.2. f_{PL} represents a focal length of a most reduction side plastic lens among the at least one plastic lens, fw represents a focal length of the projection lens at its wide-angle end, ft represents a focal length of the projection lens at its telephoto end, L represents a distance at the telephoto end between an enlargement conjugate side lens surface of the most reduction side plastic lens and the reduction conjugate side pupil on an optical axis of the projection lens, fnot represents an F-number of the projection lens at the telephoto end, and ωt (degree) represents a half field angle of the projection lens at the telephoto end.

### BACKGROUND OF THE INVENTION

Field of the Invention

The present invention relates to projection lenses used for image projection apparatuses each projecting light (image) modulated by a light modulation element such as a liquid crystal element and a digital micro-mirror device.

Description of the Related Art

Such projection lenses include zoomable projection lenses capable to perform variation of magnification (zooming). Japanese Patent Laid-Open Nos. 2001-188172, 2007-271669 and 2011-100081 disclose zoomable projection lenses each including an aspheric lens formed of plastic in a most enlargement conjugate side lens unit. In such zoomable projection lenses, increasing a power of the aspheric lens is advantageous to aberration correction.

Using lenses formed of plastic (hereinafter referred to as “plastic lenses”) enables producing aspheric lenses at low cost. However, in general, changes in refractive index of the plastic lenses with temperature fluctuation are larger than those of lenses formed of glass. Therefore, a temperature rise of the plastic lens caused by a high intensity light passing therethrough is likely to cause focus fluctuation (projected image blur). Especially in the zoomable projection lenses, such focus fluctuation is noticeable at a telephoto end.

Accordingly, the zoomable projection lenses disclosed in Japanese Patent Laid-Open Nos. 2001-188172 and 2007-271669 use plastic lenses having relatively strong powers. However, these zoomable projection lenses have small zoom magnifications. On the other hand, the zoomable projection lens disclosed in Japanese Patent Laid-Open No. 2011-100081 has a high zoom magnification. However, the plastic lens in this zoomable projection lens has an extremely weak power.

### SUMMARY OF THE INVENTION

The present invention provides a projection lens that includes a plastic lens having a strong power and is capable of reducing focus fluctuation due to temperature fluctuation while achieving a high zoom magnification.

The present invention provides as an aspect thereof a projection lens configured to project light entering from its reduction conjugate side to its enlargement conjugate side and capable to perform variation of magnification. The projection lens includes at least one plastic lens formed of plastic, having a negative power and disposed on the enlargement conjugate side further than a reduction conjugate side pupil. The following conditions are satisfied:

1.4≦ft/fw≦2.5

−0.70≦ft/f_{PL}≦−0.33

−1.0≦1−(fnot×L×tan(ωt))/ft≦0.2

where f_{PL} represents a focal length of a most reduction side plastic lens disposed at a most reduction conjugate side lens position among the at least one plastic lens, fw represents a focal length of an entire system of the projection lens at its wide-angle end, ft represents a focal length of the entire system of the projection lens at its telephoto end, L represents a distance at the telephoto end between an enlargement conjugate side lens surface of the most reduction side plastic lens and the reduction conjugate side pupil on an optical axis of the projection lens, fnot represents an F-number of the projection lens at the telephoto end, and ωt (degree) represents a half field angle of the projection lens at the telephoto end.

The present invention provides as another aspect thereof an image projection apparatus including a light modulation element and the above projection lens.

Further features and aspects of the present invention will become apparent from the following description of exemplary embodiments with reference to the attached drawings.

### BRIEF DESCRIPTION OF THE DRAWINGS

FIG. 1 illustrates sections of a zoomable projection lens that is Embodiment 1 of the present invention.

FIG. 2 illustrates aberration charts (for longitudinal aberrations and chromatic aberration of magnification) of the zoomable projection lens of Embodiment 1.

FIG. 3 illustrates sections of a zoomable projection lens that is Embodiment 2 of the present invention.

FIG. 4 illustrates aberration charts (for longitudinal aberrations and chromatic aberration of magnification) of the zoomable projection lens of Embodiment 2.

FIG. 5 illustrates sections of a zoomable projection lens that is Embodiment 3 of the present invention.

FIG. 6 illustrates aberration charts (for longitudinal aberrations and chromatic aberration of magnification) of the zoomable projection lens of Embodiment 3.

FIG. 7 illustrates sections of a zoomable projection lens that is Embodiment 4 of the present invention.

FIG. 8 illustrates aberration charts (for longitudinal aberrations and chromatic aberration of magnification) of the zoomable projection lens of Embodiment 4.

FIG. 9 illustrates an image projection apparatus using the projection lens of any one of Embodiments 1 to 4.

### DESCRIPTION OF THE EMBODIMENTS

Exemplary embodiments of the present invention will hereinafter be described with reference to the accompanying drawings.

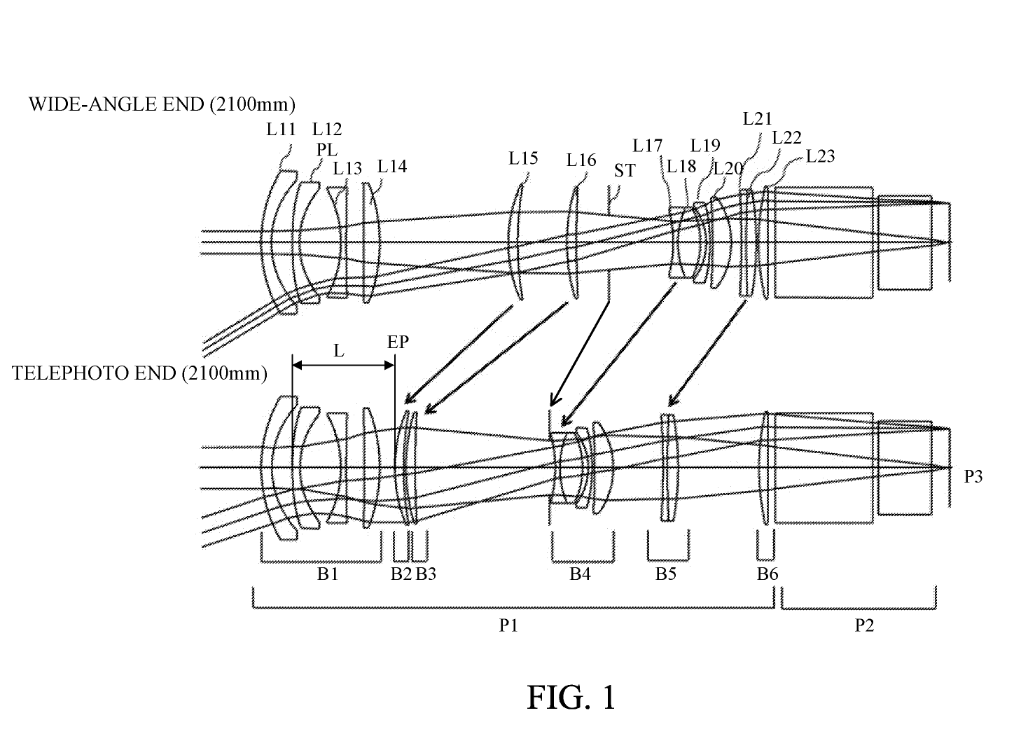

FIGS. 1, 3, 5 and 7 respectively illustrate optical configurations of image projection apparatuses including zoomable projection lenses P1 that are first to fourth embodiments (Embodiments 1 to 4) of the present invention. These zoomable projection lenses (each hereinafter simply referred to as “a projection lens”) are capable to perform variation of magnification. An upper part of each of FIGS. 1, 3, 5 and 7 illustrates the optical configuration in which the projection lens P1 is at its wide-angle end, and a lower part thereof illustrates the optical configuration in which the projection lens P1 is at its telephoto end. In each of FIGS. 1, 3, 5 and 7, a right-and-left direction corresponds to an optical axis direction in which an optical axis of the projection lens extends, a left side corresponds to an enlargement (magnification) conjugate side of the projection lens, and a right side corresponds to a reduction conjugate side thereof. Furthermore, in each of FIGS. 1, 3, 5 and 7, reference character P2 denotes an optical block including a prism, a filter and the like, and reference character P3 denotes a light modulation element such as a liquid crystal panel or a digital micro-mirror device (DMD). The light modulation element P3 is configured to modulate an entering light depending on image signals input to the image projection apparatus.

The light modulated by the light modulation element P3 enters the projection lens P1 from the reduction conjugate side through the optical block P2. The projection lens P1 is configured to project the light entering from the reduction conjugate side to the enlargement conjugate side. In each of FIGS. 1, 3, 5 and 7, reference symbol PL denotes a lens formed of plastic (hereinafter referred to as “a plastic lens”). The plastic lens PL has a negative power. Reference symbol ST denotes an aperture stop. It is desirable that the plastic lens PL be an aspheric lens.

The projection lens P1 of each embodiment enables, while achieving a high zoom magnification satisfying a condition expressed by following expression (1), reducing focus fluctuation due to temperature fluctuation.

1.4≦ft/fw≦2.5 (1)

In expression (1), fw represents a focal length of an entire system of the projection lens P1 at the wide-angle end, and ft represents a focal length of the entire system of the projection lens P1 at the telephoto end.

A lower value of ft/fw than the lower limit of expression (1) undesirably reduces merits of using a plastic lens having a strong power and an aspheric shape. On the other hand, a higher value of ft/fw than the upper limit of expression (1) undesirably increases the focus fluctuation when the temperature of the projection lens P1 increases.

It is more desirable to change the range of expression (1) as following expression (1)′.

1.7≦ft/fw≦2.2 (1)′

As described above, the refractive index the plastic lens significantly changes with the temperature fluctuation. In general, the refractive index of the plastic lens decreases as the temperature increases. In each embodiment, the plastic lens PL having the negative power is disposed on the enlargement conjugate side further than a reduction conjugate side pupil (that is, an exit pupil when the reduction conjugate side corresponds to an object side) EP.

When a temperature of the entire plastic lens increases due to the increase in temperature of the projection lens P1, the refractive index of the plastic lens decreases and thereby an absolute value of the power thereof decreases, which causes a focus fluctuation in a plus direction in the projection lens P1 as a whole. The focus fluctuation in the plus direction means that a reduction conjugate side focal point position shifts to the reduction conjugate side.

Furthermore, during image projection, a further increase in temperature is caused in, of a lens surface of the plastic lens, a partial lens surface area (corresponding to a brighter image area of a projected image than other image areas) through which a high density light passes than in other lens surface areas.

Such an increase in temperature in the partial lens surface area increases a temperature difference in the lens surface of the plastic lens, which makes it likely to cause a refractive index difference. This refractive index difference causes a focus fluctuation in a minus direction in the projection lens P1 as a whole. In addition to such properties, the plastic lens having a strong power causes a significant power fluctuation with the temperature fluctuation.

The projection lens P1 of each embodiment is configured such that the plus direction focus fluctuation and the minus direction focus fluctuation, which are caused in the plastic lens having the negative power, are canceled out. With such a configuration, it is possible to achieve, even when the plastic lens PL having a strong power is used, a projection lens being capable of sufficiently reducing the focus fluctuation due to the temperature fluctuation and thereby having a good optical performance.

In each embodiment, it is desirable that a most reduction side plastic lens PL disposed at a most reduction conjugate side lens position among at least one plastic lens (PL) disposed on the enlargement conjugate side further than the reduction conjugate side pupil EP satisfy a condition expressed by following expression (2) on changes in refractive index with respect to temperature changes,

−150×10⁻⁶≦dn/dt≦−70×10⁻⁶ (2)

In expression (2), dn/dt (° C.⁻¹) represents a change amount of the refractive index of the most reduction side plastic lens PL for a d-line (587.6 nm) with respect to the temperature change in a specific temperature range including 25° C. The specific temperature range is, for example, a so-called room temperature of 24° C. or higher and 26° C. or lower.

A lower value of dn/dt than the lower limit of expression (2) increases the refractive index difference in a lens surface of the most reduction side plastic lens PL due to the temperature difference therein, which undesirably increases the plus direction focus fluctuation in the entire projection lens. A higher value of dn/dt than the upper limit of expression (2) decreases the refractive index difference in the lens surface of the most reduction side plastic lens PL due to the temperature difference, which undesirably increases the minus direction focus fluctuation in the entire projection lens P1. Furthermore, a value of dn/dt significantly away from the range of expression (2) undesirably makes it difficult to take a balance of the refractive index fluctuation.

It is more desirable to change the range of expression (2) as following expression (2)′.

−120×10⁻⁶≦dn/dt≦−70×10⁻⁶ (2)′

Furthermore, it is desirable that the projection lens P1 of each embodiment satisfy a condition expressed by following expression (3) on the power of the most reduction side plastic lens PL.

−1.0≦ft/f_{PL}≦−0.3 (3)

In expression (3), f_{PL} represents a focal length of the most reduction side plastic lens PL.

A lower value of ft/f_{PL} than the lower limit of expression (3) makes the power of the most reduction side plastic lens PL extremely strong with respect to the power of the entire system of the projection lens P1, which undesirably increases performance fluctuation due to manufacturing errors. A higher value of ft/f_{PL} than the upper limit of expression (3) makes the power of the most reduction side plastic lens PL extremely weak with respect to the power of the entire system of the projection lens P1, which undesirably decreases an aberration correction effect of the most reduction side plastic lens PL.

It is more desirable to change the range of expression (3) as following expressions (3)′ and (3)″.

−0.80≦ft/f_{PL}≦−0.30 (3)′

−0.70≦ft/f_{PL}≦−0.33 (3)″

It is desirable that the projection lens P1 of each embodiment satisfy, in addition to the condition of expression (3), a condition expressed by following expression (4). Satisfying this condition enables keeping a state of a light flux passing through the most reduction side plastic lens PL constant.

−1.0≦1−(fnot×L×tan(ωt))/ft≦0.2 (4)

In expression (4), L represents a distance at the telephoto end between an enlargement conjugate side lens surface of the most reduction side plastic lens PL and the reduction conjugate side pupil EP on the optical axis, which is illustrated in each of FIGS. 1, 3, 5 and 7. Furthermore, fnot represents an F-number of the projection lens P1 at the telephoto end, and ωt (degree) represents a half field angle of the projection lens P1 at the telephoto end. Satisfying the condition of expression (4) enables achieving a projection lens being capable of further reducing the focus fluctuation, which is due to the temperature fluctuation of the most reduction side plastic lens PL having a strong power or due to the temperature difference in its lens surface, and thereby having a good optical performance. A lower value of 1−(fnot×L×tan(ωt))/ft than the lower limit of the expression (4) increases the temperature of the entire most reduction side plastic lens PL evenly and thereby significantly increases the entire most reduction side plastic lens PL, which makes an absolute value of the power of the most reduction side plastic lens PL and thereby undesirably increases the minus direction focus fluctuation. A higher value of 1−(fnot×L×tan(ωt))/ft than the upper limit of the expression (4) increases a density of a light flux passing through a central area of the lens surface of the most reduction side plastic lens PL at the telephoto end (that is, an on-axis light flux and an off-axis light flux overlap each other in the central area), which increases the refractive index difference in the lens surface of the most reduction side plastic lens PL and thereby undesirably increases the plus direction focus fluctuation.

It is more desirable to change the range of expression (4) as following expressions (4)′ and (4)″.

−0.6≦1−(fnot×L×tan(ωt))/ft≦0.2 (4)′

−0.4≦1−(fnot×L×tan(ωt))/ft≦0.2 (4)″

Furthermore, in the projection lens P1 of each embodiment, the most reduction side plastic lens PL is desirable to satisfy a condition expressed by following expression (5).

0.05≦k/cp≦0.30 (5)

In expression (5), k (J/mK) and cp (J/kgK) respectively represent a thermal conductivity and a specific heat of the most reduction side plastic lens PL in the above-described specific temperature.

It is more desirable to change the range of expression (5) as following expression (5)′.

0.08≦k/cp≦0.20 (5)′

In general, plastic lenses each have a property in which its specific heat is larger than those of glass lenses and its thermal conductivity is smaller than those of the glass lenses, so that a higher density light passing through a partial area of a lens surface of the plastic lens than those passing through other areas thereof is likely to generate a temperature difference in the lens surface. Satisfying the condition of expression (5) reduces the temperature difference causing a refractive index difference in an in-surface direction in the most reduction side plastic lens PL to an appropriate range. A lower value of k/cp than the lower limit of expression (5) significantly increases a temperature of a central portion of an area through which the light flux passes in the lens surface of the most reduction side plastic lens PL, which increases the refractive index difference in the lens surface and thus undesirably increases the plus direction focus fluctuation. On the other hand, a higher value of k/cp than the upper limit of expression (5) makes it likely to transmit heat to the entire most reduction side plastic lens PL, which decreases the temperature difference in the lens surface and thus undesirably increases the minus direction focus fluctuation.

Moreover, the most reduction side plastic lens PL is desirable to be disposed in a lens unit (hereinafter referred to as “a first lens unit”) located at a most enlargement conjugate side unit position in a retro focus projection lens and having a negative refractive power as a whole. In general, retro focus lenses are provided with a negative lens having a strong power at a most enlargement conjugate side position, so that providing the most reduction side plastic lens PL is advantageous in configuring the retro focus projection lens. In addition, in such a configuration, the most reduction side plastic lens PL is disposed at a position relatively far away from the aperture stop ST, so that light fluxes of respective field angles pass through extremely different positions from one another in its lens surface. Thus, the lens surface of the most reduction side plastic lens PL having an aspheric surface shape can provide a sufficient effect of the aspheric surface shape.

Specifically, when L represents the above-described distance at the telephoto end between the enlargement conjugate lens surface of the most reduction side plastic lens PL and the enlargement conjugate side pupil EP on the optical axis, and Lall represents a distance at the telephoto end from a most enlargement conjugate side lens surface (an object side surface of L11) of the projection lens P1 to an image surface (P3), it is desirable to satisfy a condition expressed by following expression (6).

0.10≦L/Lall≦0.30 (6)

Satisfying the condition of expression (6) enables increasing the distance from the enlargement conjugate side pupil EP to the aspheric lens (most reduction side plastic lens PL) to some extent, which is advantageous to aberration correction. It is more desirable to change the range of expression (6) as following expression (6)′.

0.14≦L/Lall≦0.25 (6)′

The projection lens P1 of each of Embodiments 1 to 4 is a retro focus projection lens constituted by, in order from the enlargement conjugate side to the reduction conjugate side (hereinafter simply referred to as “in order from the enlargement conjugate side”), six lens units having negative, positive, positive, negative, positive and positive powers. However, alternative embodiments of the present invention include projection lenses having other configurations. For example, the projection lens may be constituted by four or five lens units or by seven or more lens units.

Furthermore, the projection lens P1 of each of Embodiments 1 to 4 includes only one plastic lens and includes the most reduction side plastic lens PL as a most enlargement conjugate side lens or a second lens from the enlargement conjugate side. However, the projection lens P1 may include multiple plastic lenses and may include the most reduction side plastic lens PL as a third or subsequent lens from the enlargement conjugate side.

### Embodiment 1

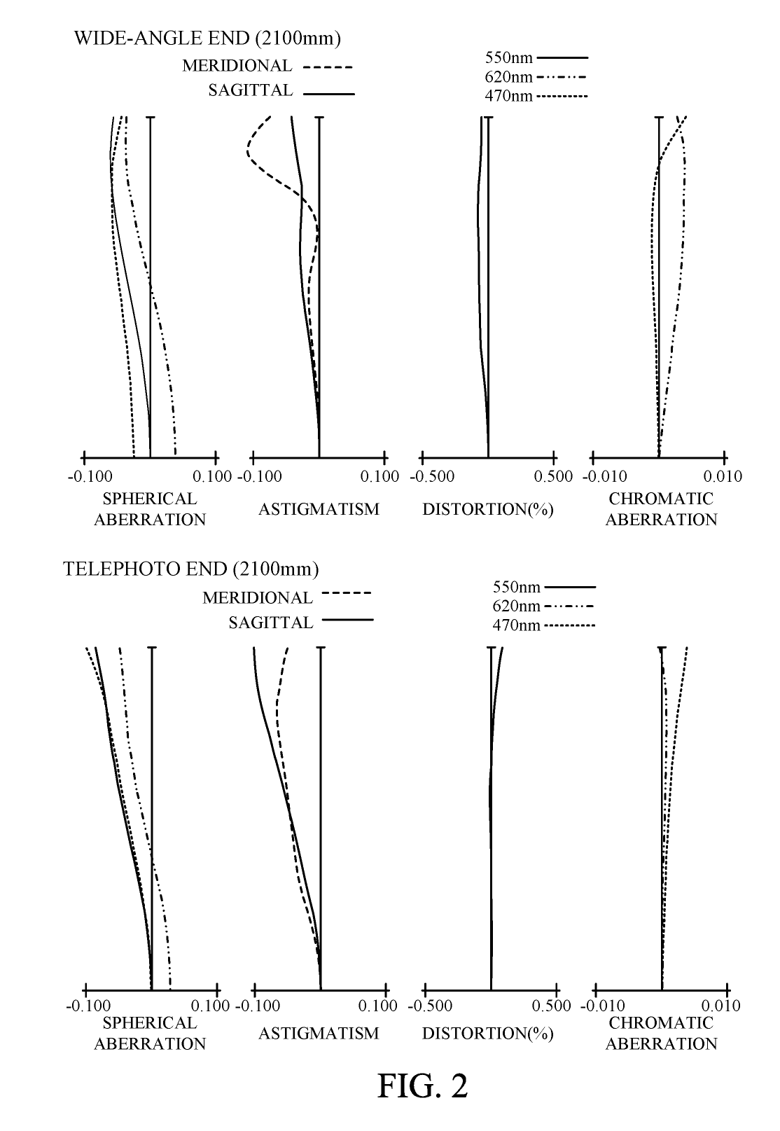

Description will be made of the projection lens P1 of Embodiment 1 illustrated in FIG. 1. FIG. 1 illustrates, as described above, the configurations of the projection lens P1 at the wide-angle end and at the telephoto end and illustrates the on-axis light flux and the off-axis light flux (maximum field angle light flux). FIG. 2 illustrates longitudinal aberrations (spherical aberration, astigmatism and distortion) and chromatic aberration of magnification of the projection lens P1 of Embodiment 1 when a projection distance is 2100 mm.

The projection lens P1 is constituted by, in order from the enlargement conjugate side, a first lens unit B1, a second lens unit B2, a third lens unit B3, a fourth lens unit B4, a fifth lens unit B5 and a sixth lens unit (most reduction side lens unit) B6. The first lens unit B1 has a negative power (in other words, a negative refractive power; the power is an inverse of its focal length) and is a lens unit unmoved (fixed) during the variation of magnification. The second lens unit B2 has a positive power and is a movable lens unit moved in the optical axis direction during the variation of magnification. The third lens unit B3 has a positive power and is a movable lens unit moved in the optical axis direction during the variation of magnification. The fourth lens unit B4 has a negative power and is a movable lens unit moved in the optical axis direction during the variation of magnification.

The fifth lens unit B5 has a positive power and is a movable lens unit moved in the optical axis direction during the variation of magnification. The sixth lens unit B6 has a positive power and is a lens unit unmoved during the variation of magnification.

The first lens unit B1 is constituted by, in order from the enlargement conjugate side, a negative lens L11, a negative lens L12, a negative lens L13 and a negative lens L14. The negative lens L12 is the most reduction side plastic lens PL. The second lens unit B2 is constituted by one positive lens L15. The third lens unit L3 is constituted by one positive lens L16. The fourth lens unit B4 is constituted by, in order from the enlargement conjugate side, a negative lens L17, a positive lens L18, a negative lens L19 and a positive lens L20. The fifth lens unit B5 is constituted by a negative lens L21 and a positive lens L22. The sixth lens unit B6 is constituted by one positive lens L23.

Table 1 ((A) to (D)) lists specific numerical values (Numerical Example 1) of this embodiment. In a lens configuration of Table 1(A), a surface number i (1, 2, 3, . . . ) represents an ordinal number of optical surfaces counted from the enlargement conjugate side, ri represents a curvature radius of an i-th optical surface, and di represents a distance (mm) between the i-th optical surface and an (i+1)-th optical surface. Moreover, ni and vi respectively represent a refractive index and an Abbe number of a material of an i-th lens for the d-line.

In Table 1(B), f, F and ω respectively represent a focal length (mm), an aperture ratio and a half field angle (degree) of the projection lens P1 of Numerical Example 1 at each of the wide-angle end, a middle zoom position and the telephoto end. An image height is a maximum distance (mm) in an in-surface direction in a reduction conjugate side imaging surface from the optical axis to an imaging point.

In Table 1(C), each variable distance (mm) of the distances di between the optical surfaces listed in Table 1(A).

When the optical surface (lens surface) has an aspheric shape, which is shown by “*” in Table 1(A), the aspheric shape is expressed by the following expression where y represents a coordinate in a radial direction orthogonal to the optical axis direction, z represents a coordinate in the optical axis direction, and k represents a conic constant. In Table 1(D), C4, C6, C8, C10, C12, C14 and C16 represent aspheric coefficients. In addition, “E±X” represents “×10^{±X}”.

z(y)=(y²/ri)/{1+[1−(1+k)(y²/ri²)]^{1/2}}+C4·y⁴+C6·y⁶+C8·y⁸+C10·y¹⁰+C12·y¹²+C14·y¹⁴+C16·y¹⁶

In Table 1(E) lists values of (1) ft/fw, (2) dn/dt, (3) ft/f_{PL}, (4) 1−(fnot×L×tan(ωt))/ft, (5) k/cp and (6) L/Lall.

The projection lens P1 of this embodiment (Numerical Example 1) satisfies the conditions of expressions (1) to (6) and thereby is a projection lens that uses the plastic lens having a strong power to sufficiently reduce focus fluctuation due to temperature fluctuation while achieving a high zoom magnification.

### Embodiment 2

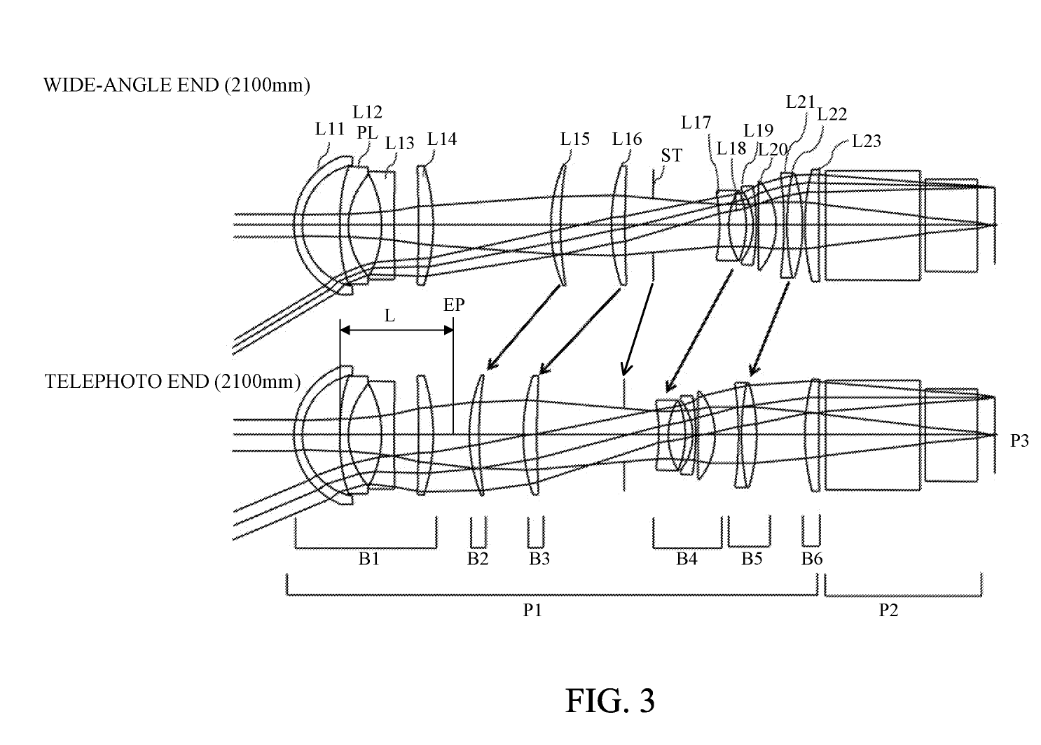

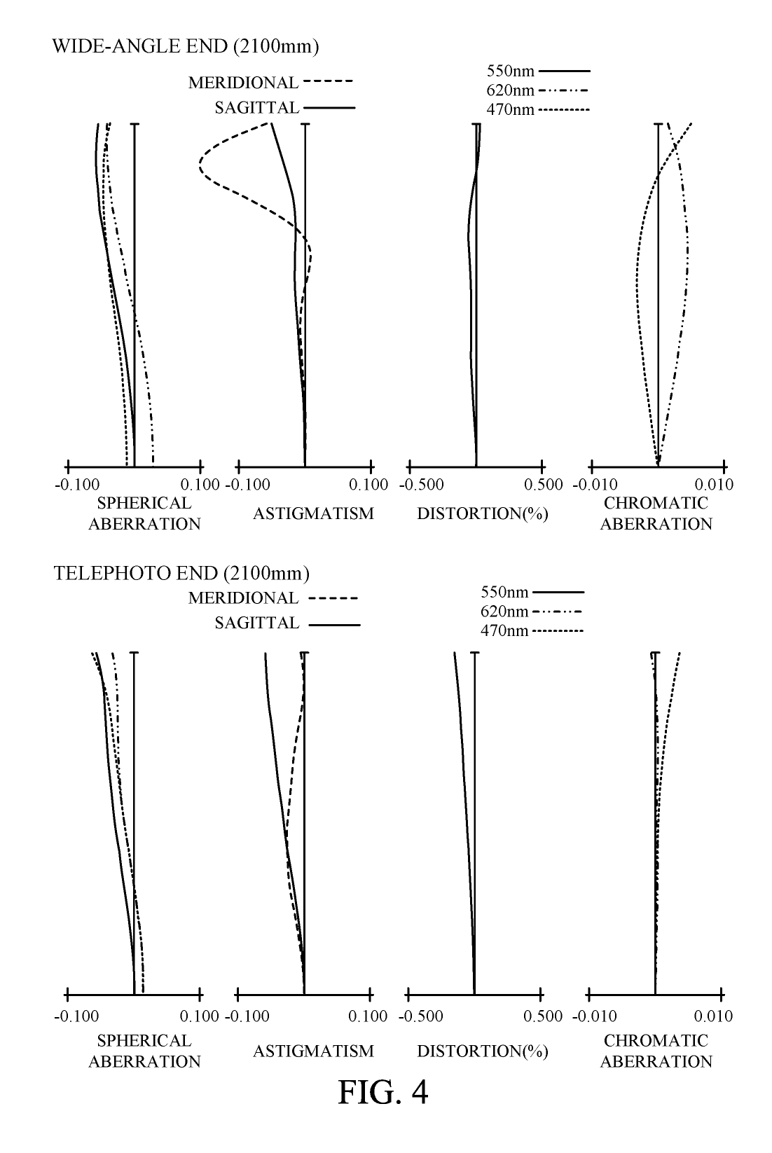

Description will be made of the projection lens P1 of Embodiment 2 illustrated in FIG. 3. FIG. 3 illustrates the configurations of the projection lens P1 at the wide-angle end and at the telephoto end and illustrates the on-axis light flux and the off-axis light flux (maximum field angle light flux). FIG. 4 illustrates longitudinal aberrations (spherical aberration, astigmatism and distortion) and chromatic aberration of magnification of the projection lens P1 of Embodiment 2 when a projection distance is 2100 mm.

The projection lens P1 of this embodiment is constituted by, as in Embodiment 1, first to sixth lens units B1 to B6, and lenses L11 to L23 have the same positive and negative powers as those in Embodiment 1. The projection lens P1 of this embodiment increases a spread of the light flux in the most reduction side plastic lens PL (L12) as compared with Embodiment 1.

Table 2((A) to (D)) lists specific numerical values (Numerical Example 2) of this embodiment. Meanings of symbols and terms in Table 2((A) to (D)) are the same as those in Table 1((A) to (D)).

In Table 2(E) lists values of (1) ft/fw, (2) dn/dt, (3) ft/f_{PL}, (4) 1−(fnot×L×tan(ωt))/ft, (5) k/cp and (6) L/Lall.

The projection lens P1 of this embodiment (Numerical Example 2) also satisfies the conditions of expressions (1) to (6) and thereby is a projection lens that uses the plastic lens having a strong power to sufficiently reduce focus fluctuation due to temperature fluctuation while achieving a high zoom magnification.

### Embodiment 3

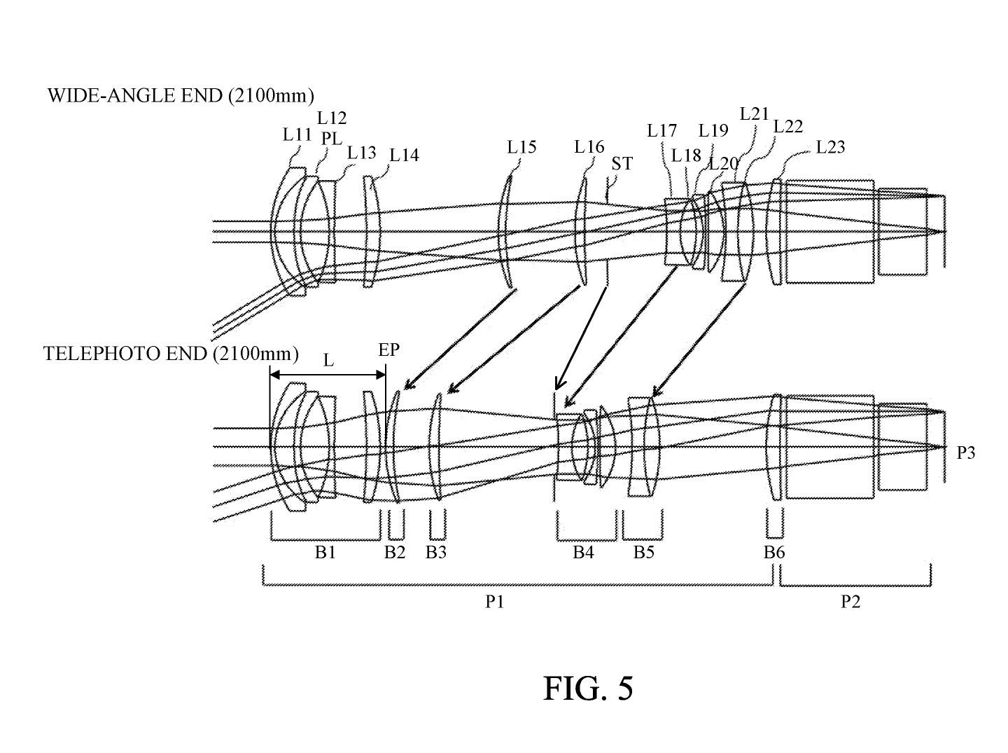

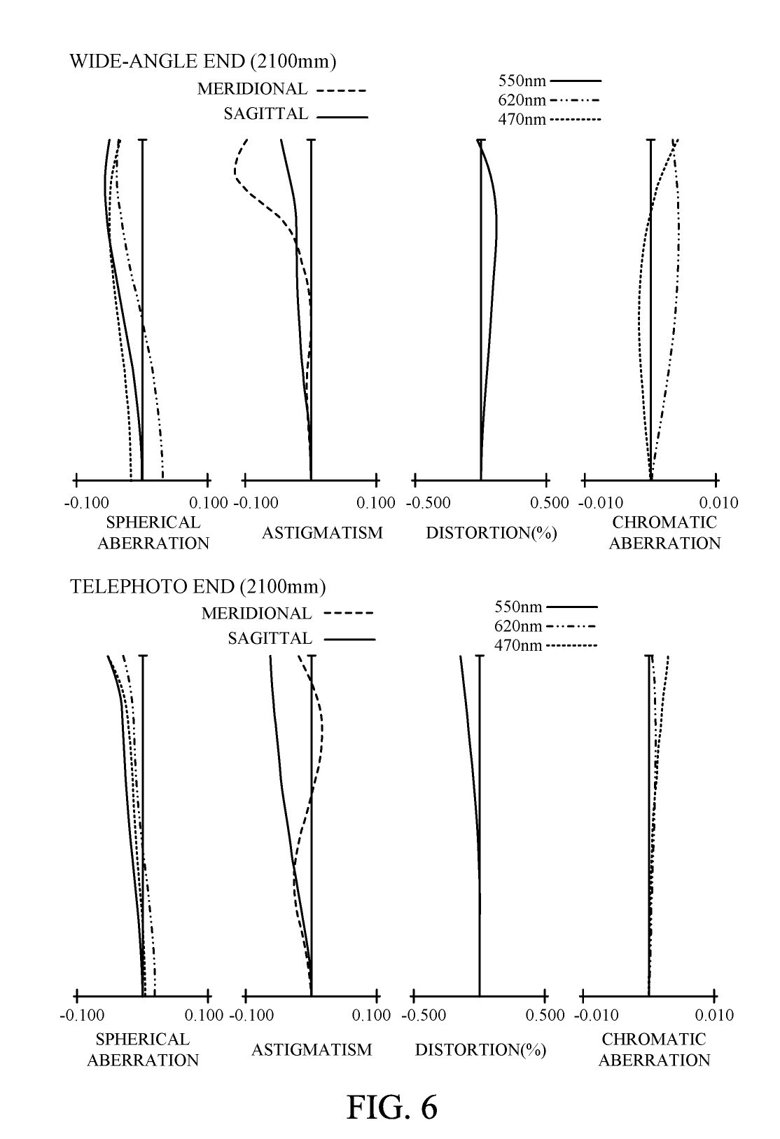

Description will be made of the projection lens P1 of Embodiment 3 illustrated in FIG. 5. FIG. 5 illustrates the configurations of the projection lens P1 at the wide-angle end and at the telephoto end and illustrates the on-axis light flux and the off-axis light flux (maximum field angle light flux). FIG. 6 illustrates longitudinal aberrations (spherical aberration, astigmatism and distortion) and chromatic aberration of magnification of the projection lens P1 of Embodiment 3 when a projection distance is 2100 mm.

The projection lens P1 of this embodiment is constituted by, as in Embodiment 1, first to sixth lens units B1 to B6, and lenses L11 to L23 have the same positive and negative powers as those in Embodiment 1.

The projection lens P1 of this embodiment is different from those of Embodiments 1 and 2 in that the reduction side plastic lens PL is the negative lens L11 disposed at a most enlargement conjugate side lens position of the projection lens P1. The negative lens L12 in the first lens unit B1 is a glass aspheric lens that is a lens convex toward the enlargement conjugate side.

Table 3((A) to (D)) lists specific numerical values (Numerical Example 3) of this embodiment. Meanings of symbols and terms in Table 3((A) to (D)) are the same as those in Table 1((A) to (D)).

In Table 3(E) lists values of (1) ft/fw, (2) dn/dt, (3) ft/f_{PL}, (4) 1−(fnot×L×tan(ωt))/ft, (5) k/cp and (6) L/Lall.

The projection lens P1 of this embodiment (Numerical Example 3) also satisfies the conditions of expressions (1) to (6) and thereby is a projection lens that uses the plastic lens having a strong power to sufficiently reduce focus fluctuation due to temperature fluctuation while achieving a high zoom magnification.

### Embodiment 4

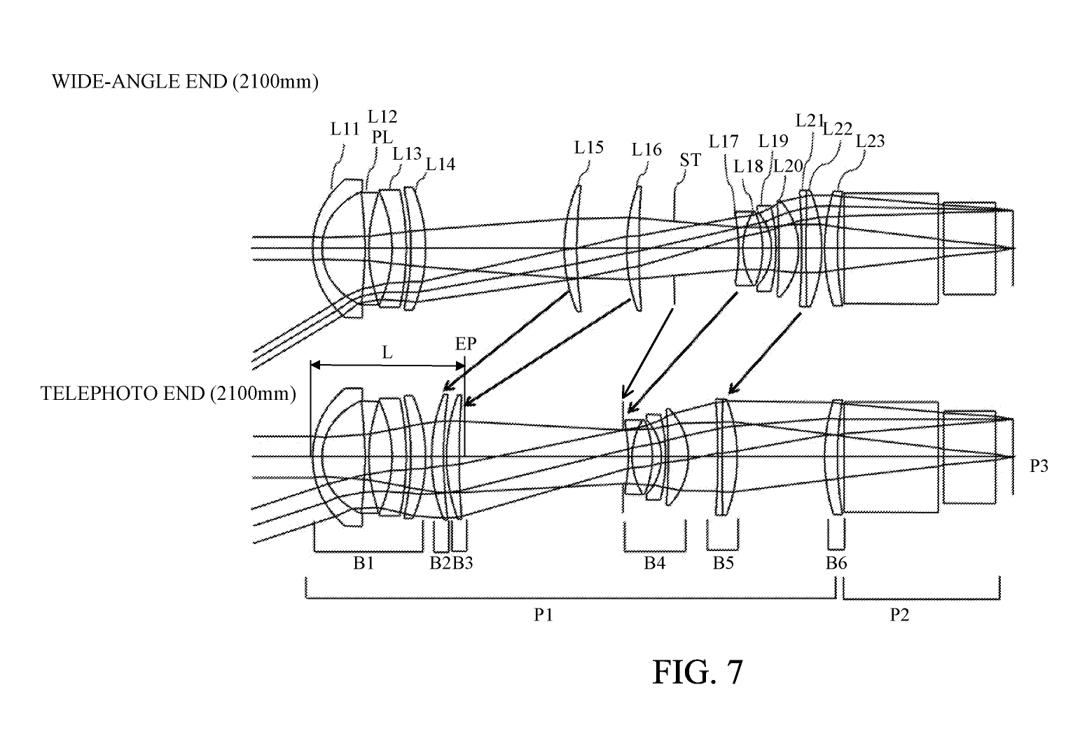

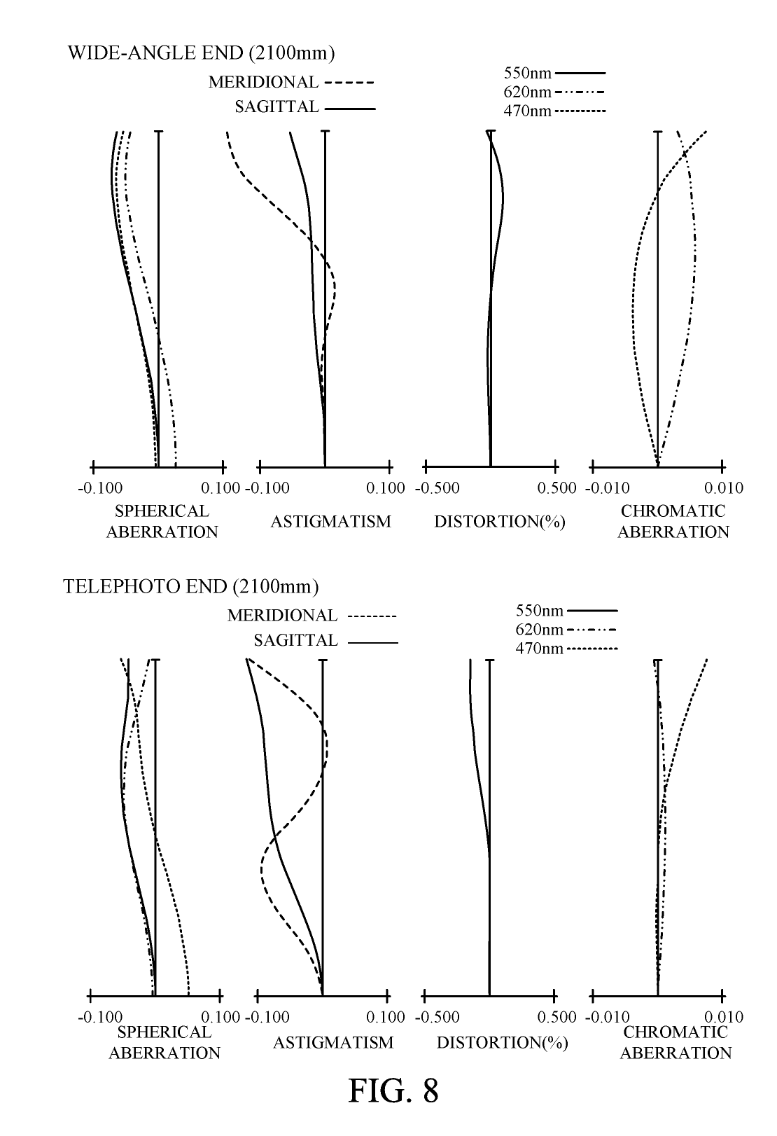

Description will be made of the projection lens P1 of Embodiment 4 illustrated in FIG. 7. FIG. 7 illustrates the configurations of the projection lens P1 at the wide-angle end and at the telephoto end and illustrates the on-axis light flux and the off-axis light flux (maximum field angle light flux). FIG. 8 illustrates longitudinal aberrations (spherical aberration, astigmatism and distortion) and chromatic aberration of magnification of the projection lens P1 of Embodiment 4 when a projection distance is 2100 mm.

The projection lens P1 of this embodiment is constituted by, as in Embodiment 1, first to sixth lens units B1 to B6, and lenses L11 to L23 have the same positive and negative powers as those in Embodiment 1. The projection lens P1 of this embodiment increases a spread of the light flux in the most reduction side plastic lens PL (L11) as compared with Embodiment 3. The projection lens P1 of this embodiment is different from that of Embodiment 3 in that the negative lens L12 in the first lens unit B1 is a glass aspheric lens that is a biconcave lens.

Table 4((A) to (D)) lists specific numerical values (Numerical Example 4) of this embodiment. Meanings of symbols and terms in Table 3((A) to (D)) are the same as those in Table 1((A) to (D)). In Table 4(E) lists values of (1) ft/fw, (2) dn/dt, (3) ft/f_{PL}, (4) 1−(fnot×L×tan(ωt))/ft, (5) k/cp and (6) L/Lall.

The projection lens P1 of this embodiment (Numerical Example 4) also satisfies the conditions of expressions (1) to (6) and thereby is a projection lens that uses the plastic lens having a strong power to sufficiently reduce focus fluctuation due to temperature fluctuation while achieving a high zoom magnification.

### Embodiment 5

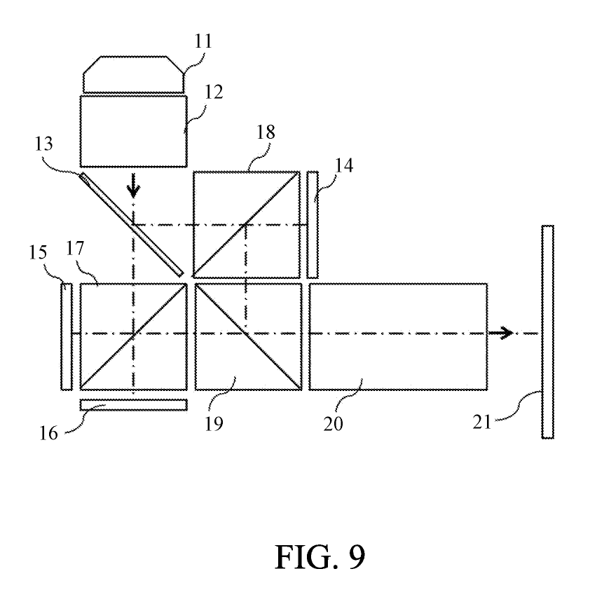

FIG. 9 illustrates a configuration of an image projection apparatus using any one of the projection lenses of Embodiments 1 to 4 and a reflective liquid crystal panel as a light modulation element.

Light from a light source 11 enters an illumination optical system 12 to be converted into a polarized light having a predetermined polarization direction. The light (white light) from the illumination optical system 12 is separated into three color lights of R, G and B by a color separation optical system constituted by a color separation mirror 13 and a polarization beam splitter 17.

One of the three color lights is introduced, through a polarization beam splitter 18, to a reflective liquid crystal panel 14 to be modulated and reflected thereby. The other two lights separated by the polarization beam splitter 17 are respectively introduced to reflective liquid crystal panels 15 and 16 to be modulated and reflected thereby.

The three color lights exiting from the reflective liquid crystal panels 14, 15 and 16 are combined by a color combination optical system constituted by the polarization beam splitters 17 and 18 and a color combination prism 19 and then introduced to a projection lens 20 that is any one of the projection lenses of Embodiments 1 to 4 to be projected onto a projection surface 21.

This embodiment using the projection lens of any one of Embodiments 1 to 4 achieves an image projection apparatus capable of sufficiently correcting aberrations, widely selecting a projection field angle and reducing focus fluctuation of projected images due to temperature fluctuation.

TABLE 1
NUMERICAL EXAMPLE 1
(A) LENS CONFIGURATION

| Surface No. | r | d | n | ν |
|---|---|---|---|---|
| 1 | 46.561 | 3.5 | 1.80518 | 25.4 |
| 2 | 30 | 6.84 | | |
| 3* | 146.496 | 2.5 | 1.5311 | 55.9 |
| 4* | 30.532 | 13.68 | | |
| 5 | −35.375 | 1.7 | 1.497 | 81.5 |
| 6 | 699.15 | 5.93 | | |
| 7 | −703.231 | 5.17 | 1.8061 | 33.3 |
| 8 | −54.757 | (Variable) | | |
| 9 | 47.659 | 3.03 | 1.48749 | 70.2 |
| 10 | 107.112 | (Variable) | | |
| 11 | 64.478 | 3.05 | 1.834 | 37.2 |
| 12 | 364.567 | (Variable) | | |
| 13(Stop) | ∞ | (Variable) | | |
| 14 | −42.8 | 1.5 | 1.8061 | 33.3 |
| 15 | 28.029 | 7.54 | 1.618 | 63.4 |
| 16 | −27.155 | 1.9 | | |
| 17 | −19.669 | 1.3 | 1.80518 | 25.4 |
| 18 | −50.216 | 0.75 | | |
| 19 | −254.756 | 6.29 | 1.497 | 81.5 |
| 20 | −24.88 | (Variable) | | |
| 21 | −350.539 | 1.6 | 1.69895 | 30.1 |
| 22 | 394.819 | 3.48 | 1.80518 | 25.4 |
| 23 | −100.862 | (Variable) | | |
| 24 | 81.339 | 3.1 | 1.80518 | 25.4 |
| 25 | −952.777 | 2.3 | | |
| 26 | ∞ | 32.32 | 1.51633 | 64.1 |
| 27 | ∞ | 1.87 | | |
| 28 | ∞ | 17.7 | 1.80518 | 25.4 |
| 29 | ∞ | 4.98 | | |
| 30 | ∞ | 0.35 | | |
| Image surface | ∞ | | | |

| | | |
|---|---|---|
| Wide-angle end | Middle | Telephoto end |

(B)

| | | | |
|---|---|---|---|
| f | 21.78 | 30.74 | 39.29 |
| F | 2.8 | 2.78 | 2.81 |
| ω | 31.03 | 23.08 | 18.44 |
| Image height | 13.1 | 13.1 | 13.1 |

(C)

| | | | |
|---|---|---|---|
| d8 | 42.59 | 16.98 | 4.94 |
| d11 | 16.44 | 12.39 | 0.75 |
| d13 | 10.86 | 30.01 | 44.56 |
| d14 | 21.24 | 10.27 | 1.75 |
| d21 | 3.25 | 13.5 | 16.37 |
| d24 | 0.75 | 11.99 | 26.76 |

(D) ASPHERIC COEFFICIENT

Surface

| | 3 | 4 |
|---|---|---|
| K | 0 | 0 |
| C4 | 1.997E−05 | 1.664E−05 |
| C6 | −4.568E−08 | −3.851E−08 |
| C8 | 2.814E−11 | −3.068E−11 |
| C10 | 1.258E−13 | 5.547E−14 |
| C12 | −1.191E−16 | 1.436E−15 |
| C14 | −4.229E−19 | −5.177E−18 |
| C16 | 5.989E−22 | 5.219E−21 |

(E) VALUE OF CONDITIONAL EXPRESSIONS

| | |
|---|---|
| (1) | 1.80 |
| (2) | −100 × 10⁻⁶ |
| (3) | −0.536 |
| (4) | 0.159 |
| (5) | 0.102 |
| (6) | 0.155 |

TABLE 2
NUMERICAL EXAMPLE 2
(A) LENS CONFIGURATION

| Surface No. | r | d | n | ν |
|---|---|---|---|---|
| 1 | 25.361 | 2.79 | 1.80518 | 25.4 |
| 2 | 21.117 | 12.91 | | |
| 3* | 126.089 | 3.04 | 1.5311 | 55.9 |
| 4* | 26.913 | 11.17 | | |
| 5 | −37.843 | 4.43 | 1.497 | 81.5 |
| 6 | 836.895 | 8.37 | | |
| 7 | −638.625 | 5 | 1.8061 | 33.3 |
| 8 | −69.252 | (Variable) | | |
| 9 | 53.038 | 3.25 | 1.48749 | 70.2 |
| 10 | 120.63 | (Variable) | | |
| 11 | 65.086 | 4.6 | 1.834 | 37.2 |
| 12 | 375.997 | (Variable) | | |
| 13(Stop) | ∞ | (Variable) | | |
| 14 | −60.744 | 3.17 | 1.8061 | 33.3 |
| 15 | 24.285 | 5.85 | 1.618 | 63.4 |
| 16 | −31.31 | 2.56 | | |
| 17 | −19.777 | 1 | 1.80518 | 25.4 |
| 18 | −84.599 | 0.75 | | |
| 19 | 4513.337 | 5.96 | 1.497 | 81.5 |
| 20 | −23.878 | (Variable) | | |
| 21 | −127.888 | 1 | 1.69895 | 30.1 |
| 22 | 92.693 | 5.28 | 1.80518 | 25.4 |
| 23 | −58.896 | (Variable) | | |
| 24 | 77.231 | 4.9 | 1.80518 | 25.4 |
| 25 | 2120.847 | 2.3 | | |
| 26 | ∞ | 32.32 | 1.51633 | 64.1 |
| 27 | ∞ | 1.87 | | |
| 28 | ∞ | 17.7 | 1.80518 | 25.4 |
| 29 | ∞ | 4.98 | | |
| 30 | ∞ | 0.55 | | |
| Image surface | ∞ | | | |

| | | |
|---|---|---|
| Wide-angle end | Middle | Telephoto end |

(B)

| | | | |
|---|---|---|---|
| f | 21.86 | 30.86 | 39.45 |
| F | 2.8 | 2.78 | 2.81 |
| ω | 30.93 | 23 | 18.37 |
| Image height | 13.1 | 13.1 | 13.1 |

(C)

| | | | |
|---|---|---|---|
| d8 | 40.36 | 12.37 | 1.50 |
| d11 | 17.5 | 15.26 | 1.64 |
| d13 | 9.56 | 30.04 | 47.09 |
| d14 | 22.87 | 11.84 | 1.73 |
| d21 | 2.86 | 7.92 | 9.22 |
| d24 | 0.75 | 16.46 | 32.71 |

(D) ASPHERIC COEFFICIENT

Surface

| | 3 | 4 |
|---|---|---|
| K | 0.000E+00 | 0.000E+00 |
| C4 | 1.929E−05 | 1.413E−05 |
| C6 | −4.454E−08 | −4.202E−08 |
| C8 | 3.547E−11 | −4.565E−11 |
| C10 | 1.141E−13 | 6.285E−14 |
| C12 | −1.397E−16 | 1.463E−15 |
| C14 | −3.253E−19 | −5.369E−18 |
| C16 | 4.796E−22 | 4.514E−21 |

(E) VALUE OF CONDITIONAL EXPRESSIONS

| | |
|---|---|
| (1) | 1.80 |
| (2) | −1.00 × 10⁻⁶ |
| (3) | −0.625 |
| (4) | 0.065 |
| (5) | 0.102 |
| (6) | 0.165 |

TABLE 3
NUMERICAL EXAMPLE 3
(A) LENS CONFIGURATION

| Surface No. | r | d | n | ν |
|---|---|---|---|---|
| 1* | 41.945 | 1.5 | 1.5311 | 55.9 |
| 2* | 24.336 | 7.1 | | |
| 3* | 74.723 | 2.4 | 1.58313 | 59.4 |
| 4* | 33.044 | 10.59 | | |
| 5 | −45.051 | 1.84 | 1.497 | 81.5 |
| 6 | 433.553 | 13.88 | | |
| 7 | −202.367 | 5 | 1.8061 | 33.3 |
| 8 | −65.111 | (Variable) | | |
| 9 | 52.542 | 2.88 | 1.48749 | 70.2 |
| 10 | 97.324 | (Variable) | | |
| 11 | 58.048 | 3.58 | 1.834 | 37.2 |
| 12 | 300.254 | (Variable) | | |
| 13(Stop) | ∞ | (Variable) | | |
| 14 | −87.402 | 5 | 1.8061 | 33.3 |
| 15 | 23.719 | 5.79 | 1.618 | 63.4 |
| 16 | −37.471 | 2.68 | | |
| 17 | −21.245 | 1 | 1.80518 | 25.4 |
| 18 | −148.075 | 0.75 | | |
| 19 | 532.95 | 5.81 | 1.497 | 81.5 |
| 20 | −24.44 | (Variable) | | |
| 21 | −98.121 | 4.51 | 1.69895 | 30.1 |
| 22 | 74.389 | 5.7 | 1.80518 | 25.4 |
| 23 | −58.294 | (Variable) | | |
| 24 | 68.244 | 5 | 1.80518 | 25.4 |
| 25 | 504.907 | 2.3 | | |
| 26 | ∞ | 32.32 | 1.51633 | 64.1 |
| 27 | ∞ | 1.87 | | |
| 28 | ∞ | 17.7 | 1.80518 | 25.4 |
| 29 | ∞ | 4.98 | | |
| 30 | ∞ | 1.1 | | |
| Image surface | ∞ | | | |

| | | |
|---|---|---|
| Wide-angle end | Middle | Telephoto end |

(B)

| | | | |
|---|---|---|---|
| f | 21.78 | 30.74 | 39.28 |
| F | 2.8 | 2.81 | 2.81 |
| ω | 31.03 | 23.08 | 18.44 |
| Image height | 13.1 | 13.1 | 13.1 |

(C)

| | | | |
|---|---|---|---|
| d8 | 43.68 | 12.72 | 2.12 |
| d11 | 25.49 | 26.49 | 13.15 |
| d13 | 8.42 | 26.85 | 42.6 |
| d14 | 21.85 | 11.8 | 1.59 |
| d21 | 0.75 | 5.14 | 6.12 |
| d24 | 4.84 | 22.03 | 39.44 |

(D) ASPHERIC COEFFICIENT

| | Surface | | | |
|---|---|---|---|---|
| | 1 | 2 | 3 | 4 |
| K | 0.000E+00 | 0.000E+00 | 0.000E+00 | 0.000E+00 |
| C4 | −1.712E−07 | −8.539E−08 | 1.952E−05 | 1.625E−05 |
| C6 | 9.937E−11 | 5.184E−10 | −4.411E−08 | −4.190E−08 |
| C8 | −7.595E−13 | −4.833E−12 | 2.784E−11 | −2.100E−11 |
| C10 | −3.682E−15 | −7.984E−15 | 1.415E−13 | 7.478E−14 |
| C12 | −1.739E−18 | 1.377E−17 | −7.537E−17 | 1.437E−15 |
| C14 | 7.178E−21 | 6.026E−20 | −4.038E−19 | −5.245E−18 |
| C16 | 2.082E−24 | −3.831E−23 | 3.088E−22 | 4.757E−21 |

(E) VALUE OF CONDITIONAL EXPRESSIONS

| | |
|---|---|
| (1) | 1.80 |
| (2) | −100 × 10⁻⁶ |
| (3) | −0.349 |
| (4) | −0.058 |
| (5) | 0.102 |
| (6) | 0.179 |

TABLE 4
NUMERICAL EXAMPLE 4
(A) LENS CONFIGURATION

| Surface No. | r | d | n | ν |
|---|---|---|---|---|
| 1* | 33.808 | 3.16 | 1.5311 | 55.9 |
| 2* | 21.071 | 14.69 | | |
| 3* | −90.661 | 1.5 | 1.58313 | 59.4 |
| 4* | 62.748 | 7.8 | | |
| 5 | −45.244 | 5 | 1.497 | 81.5 |
| 6 | −86.806 | 1.58 | | |
| 7 | −92.562 | 5 | 1.8061 | 33.3 |
| 8 | −52.894 | (Variable) | | |
| 9 | 55.698 | 4.23 | 1.48749 | 70.2 |
| 10 | 159.429 | (Variable) | | |
| 11 | 61.664 | 4.3 | 1.834 | 37.2 |
| 12 | 269.816 | (Variable) | | |
| 13(Stop) | ∞ | (Variable) | | |
| 14 | −62.18 | 1.5 | 1.8061 | 33.3 |
| 15 | 25.063 | 6.78 | 1.618 | 63.4 |
| 16 | −32.031 | 3.06 | | |
| 17 | −19.04 | 1.5 | 1.80518 | 25.4 |
| 18 | −59.409 | 1 | | |
| 19 | −203.612 | 6.85 | 1.497 | 81.5 |
| 20 | −24.485 | (Variable) | | |
| 21 | −275.888 | 1.5 | 1.69895 | 30.1 |
| 22 | 1089.521 | 5.27 | 1.80518 | 25.4 |
| 23 | −53.187 | (Variable) | | |
| 24 | 63.473 | 4.53 | 1.80518 | 25.4 |
| 25 | 115.311 | 2.3 | | |
| 26 | ∞ | 32.32 | 1.51633 | 64.1 |
| 27 | ∞ | 1.87 | | |
| 28 | ∞ | 17.7 | 1.80518 | 25.4 |
| 29 | ∞ | 4.98 | | |
| 30 | ∞ | 0.55 | | |
| Image surface | ∞ | | | |

| | | |
|---|---|---|
| Wide-angle end | Middle | Telephoto end |

(B)

| | | | |
|---|---|---|---|
| f | 21.82 | 30.8 | 40.28 |
| F | 2.8 | 2.81 | 2.78 |
| ω | 30.98 | 23.04 | 18.02 |
| Image height | 13.1 | 13.1 | 13.1 |

(C)

| | | | |
|---|---|---|---|
| d8 | 47.75 | 15.15 | 2 |
| d11 | 17.04 | 18.27 | 1 |
| d13 | 12.11 | 30.62 | 56.33 |
| d14 | 22.15 | 14.78 | 1.71 |
| d21 | 1 | 7.58 | 10.09 |
| d24 | 1 | 14.65 | 29.92 |

(D) ASPHERIC COEFFICIENT

| | Surface | | | |
|---|---|---|---|---|
| | 1 | 2 | 3 | 4 |
| K | 0 | 0 | 0 | 0 |
| C4 | 5.195E−06 | 4.318E−06 | 1.730E−05 | 1.467E−05 |
| C6 | 3.094E−09 | 6.232E−09 | −4.800E−08 | −4.585E−08 |
| C8 | −2.607E−12 | 1.621E−11 | 1.839E−11 | −2.398E−11 |
| C10 | −8.910E−15 | −3.370E−14 | 1.484E−13 | 4.591E−14 |
| C12 | −1.396E−17 | −1.441E−16 | −1.001E−16 | 1.433E−15 |
| C14 | −3.902E−21 | −1.671E−19 | −5.746E−19 | −4.998E−18 |
| C16 | 5.050E−23 | −1.486E−22 | 6.790E−22 | 4.756E−21 |

(E) VALUE OF CONDITIONAL EXPRESSIONS

| | |
|---|---|
| (1) | 1.84 |
| (2) | −100 × 10⁻⁶ |
| (3) | −0.349 |
| (4) | −0.248 |
| (5) | 0.102 |
| (6) | 0.229 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2015-231840, filed on Nov. 27, 2015, and 2016-216668, filed on Nov. 4, 2016 which are hereby incorporated by reference herein in their entirety.

What is claimed is:

1. A projection lens configured to project light entering from its reduction conjugate side to its enlargement conjugate side and capable to perform variation of magnification, the projection lens comprising:
at least one plastic lens formed of plastic, having a negative power and disposed on the enlargement conjugate side further than a reduction conjugate side pupil,
wherein the following conditions are satisfied:
1.4≦ft/fw≦2.5
−0.70≦ft/f_{PL}≦−0.33
−1.0≦1−(fnot×L×tan(ωt))/ft≦0.2
where f_{PL} represents a focal length of a most reduction side plastic lens disposed at a most reduction conjugate side lens position among the at least one plastic lens, fw represents a focal length of an entire system of the projection lens at its wide-angle end, ft represents a focal length of the entire system of the projection lens at its telephoto end,
L represents a distance at the telephoto end between an enlargement conjugate side lens surface of the most reduction side plastic lens and the reduction conjugate side pupil on an optical axis of the projection lens, fnot represents an F-number of the projection lens at the telephoto end, and ωt (degree) represents a half field angle of the projection lens at the telephoto end.

2. A projection lens according to claim 1, wherein the following condition is satisfied:
−150×10⁻⁶≦dn/dt≦−70×10⁻⁶
where dn/dt (° C.⁻¹) represents a change amount of a refractive index of the most reduction side plastic lens for a d-line with respect to a temperature change in a specific temperature range including 25° C.

3. A projection lens according to claim 2, wherein the following condition is satisfied:
0.05≦k/cp≦0.30
where k (J/mK) and cp (J/kgK) respectively represent a thermal conductivity and a specific heat of the most reduction side plastic lens in the specific temperature.

4. A projection lens according to claim 1, wherein the following condition is satisfied:
0.10≦L/Lall≦0.30
where Lall represents a distance at the telephoto end from a most enlargement conjugate side lens surface of the projection lens to an image surface thereof.

5. A projection lens according to claim 1, wherein the projection lens comprises in order from the enlargement conjugate side to the reduction conjugate side:
a first lens unit having a negative power and being unmoved during the variation of magnification;
at least one movable lens unit being moved during the variation of magnification; and
a most reduction side lens unit disposed at a most reduction conjugate side unit position in the projection lens and being unmoved during the variation of magnification, and
wherein the most reduction side plastic lens is disposed in the first lens unit.

6. A projection lens according to claim 1, wherein the projection lens comprises in order from the enlargement conjugate side to the reduction conjugate side:
a first lens unit having a negative power;
a second lens unit having a positive power;
a third lens unit having a positive power;
a fourth lens unit having a negative power;
a fifth lens unit having a positive power; and
a sixth lens unit having a positive power, and
wherein the most reduction side plastic lens is disposed in the first lens unit.

7. A projection lens according to claim 1, wherein the most reduction side plastic lens has an aspheric lens surface.

8. An image projection apparatus comprising:
a light modulation element configured to modulate light; and
a projection lens configured to project the light entering from the light modulation element disposed on a reduction conjugate side of the projection lens to an enlargement conjugate side thereof and capable to perform variation of magnification,
wherein the projection lens comprises:
at least one plastic lens formed of plastic, having a negative power and disposed on the enlargement conjugate side further than a reduction conjugate side pupil, and
wherein the following conditions are satisfied:
1.4≦ft/fw≦2.5
−0.70≦ft/f_{PL}≦−0.33
−1.0≦1−(fnot×L×tan(ωt))/ft≦0.2
where f_{PL} represents a focal length of a most reduction side plastic lens disposed at a most reduction conjugate side lens position among the at least one plastic lens, fw represents a focal length of an entire system of the projection lens at its wide-angle end, ft represents a focal length of the entire system of the projection lens at its telephoto end, L represents a distance at the telephoto end between an enlargement conjugate side lens surface of the most reduction side plastic lens and the reduction conjugate side pupil on an optical axis of the projection lens, fnot represents an F-number of the projection lens at the telephoto end, and ωt (degree) represents a half field angle of the projection lens at the telephoto end.
